(19) United States
(12) Patent Application Publication
(10) Pub. No.: US 2010/0279121 A1
(43) Pub. Date: Nov. 4, 2010

(54) PRIMER COMPOSITION CONTAINING ALDIMINE

(75) Inventors: Urs Burckhardt, Zurich (CH); Wolf-Rüdiger Huck, Gockhausen (CH); Jolanda Sutter, Allschwil (CH)

Correspondence Address: OLIFF & BERRIDGE, PLC, P.O. BOX 320850, ALEXANDRIA, VA, 22320-4850, US

(73) Assignee: SIKA TECHNOLOGY AG, Baar (CH)

(21) Appl. No.: 12/809,764

(22) PCT Filed: Dec. 19, 2008
(86) PCT No.: PCT/EP2008/067973

§ 371 Date: Jul. 14, 2010

(30) Foreign Application Priority Data
Dec. 21, 2007 (EP) 07150316.3

(51) Int. Cl. B32B 27/40; C09J 4/00; C09J 175/04; B32B 37/12; B05D 1/00; B05D 1/38

(52) U.S. Cl. 428/423.1; 528/59; 528/48; 528/58; 528/55; 524/589; 156/331.4; 427/407.1; 427/407.2

(57) ABSTRACT

The invention relates to the use of compositions containing a polyaldimine ALD of formula (I) as primers for adhesives or sealants. It turned out that said primers accelerate adhesion especially in winter weather without reducing the open time of the primer. Said accelerated adhesion is particularly important for fast-curing polyurethane adhesives or sealants.

### TECHNICAL FIELD

The present invention relates to the field of primer compositions for improving the adhesion of adhesives or sealants to substrates.

### STATE OF THE ART

Polyurethane compositions have already been used for some time as primers in order to improve the adhesion of adhesives and sealants to different substrates. Given the great variety and constant further development of such substrates, there is always a need for new and specific primers.

A particularly great weakness of the known polyurethane-based primer compositions is the slow crosslinking thereof, which leads to a slow buildup of strength. Especially when adhesive bonding is undertaken only a short time after the application of the primer, it can take a long time until the primer is fully crosslinked and hence can ensure the final strength of the adhesive bond. Especially in the case of adhesive bonds in industrial processes, fast-setting adhesives are often used, which, only a short time after application, have a high intrinsic strength, known as the early strength. Such adhesives place particularly high demands on the crosslinking rate of the primer, in order that they can transfer their early strength to the entire adhesive bond. On the other hand, the primer should not only crosslink rapidly but also have a long open time and hence still be capable of adhesive bonding over a long period, i.e. build up adhesion to the adhesive, even a long time after the application thereof, for example after several weeks or months.

The known primer compositions additionally have a great weakness in that they tend to possess slow buildup of adhesion, especially at low temperatures and/or air humidity, i.e. climatic conditions as frequently encountered typically in winter. This is especially troublesome when fast-curing or accelerated adhesives—for example polyurethane adhesives to which a water-based paste is added—are used.

Polyurethane compositions which comprise capped amines, especially in the form of aldimines have already been known for some time for use in adhesives and sealants. Such adhesives and sealants are often notable for a high early strength, as described, for example, in WO 03/059978 A1, WO 2004/013200 A1 and WO 2007/036574 A1.

### SUMMARY OF THE INVENTION

It is therefore an object of the present invention to provide an improved primer composition which remedies the disadvantages of the prior art.

It has now been found that, surprisingly, the use of a primer composition according to claim 1 is capable of solving this problem.

The use of this primer composition leads to rapid buildup of adhesion. More particularly, this is also the case at low temperatures and/or low air humidities, i.e. typical climatic conditions in winter. It is particularly advantageous, however, that this does not shorten the open time, i.e. the maximum time up to application of an adhesive or sealant. It has even been found that, at low temperatures and/or low air humidities, the open time of the primers can even be increased in spite of a decrease in the minimum flashoff time compared to the corresponding primers of claim 1 without aldimine. The primers thus have a significantly greater time window in which they can be used as primers. Finally, it has been found that these advantageous properties, more particularly, are also present in the case of fast-curing adhesives.

In addition, a process for adhesive bonding as claimed in claim 16, a process for sealing as claimed in claim 18 and an article as claimed in claim 22 constitute further aspects of the invention.

Preferred embodiments of the invention are the subject-matter of the dependent claims.

### WAYS OF PERFORMING THE INVENTION

In a first aspect, the present invention relates to the use of a primer composition comprising

at least one polyaldimine ALD of the formula (I)

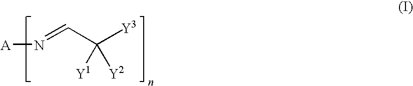

and at least one polyisocyanate P as a primer for adhesives or sealants.

In this formula, A is the remainder of a primary aliphatic amine after the removal of n primary amino groups;
Y¹ and Y²
   are each independently a monovalent hydrocarbon radical having 1 to 4 carbon atoms,
or
   together are a divalent hydrocarbon radical having 4 to 5 carbon atoms;
Y³ is a branched or unbranched hydrocarbon radical having 1 to 8 carbon atoms, optionally with cyclic moieties and/or optionally with at least one heteroatom, especially oxygen in the form of ether, ester or aldehyde groups;
and n is 2 or 3.

Preferably, Y¹ and Y² are each a methyl group.

Y³ is preferably a radical of the formula (II)

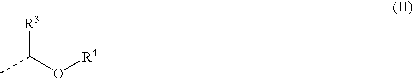

In this formula, R³ is a hydrogen atom or a linear or branched alkyl group having 1 to 4 carbon atoms;

R⁴ is either
a hydrocarbon radical having 1 to 7 carbon atoms or a

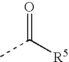

radical where R⁵ is a hydrogen atom or a hydrocarbon radical having 1 to 6 carbon atoms.

A particularly preferred polyaldimine ALD of the formula (I) is the polyaldimine ALD of the formula (III)

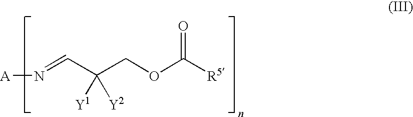

where R⁵′ is a methyl, ethyl, n-propyl, isopropyl, n-butyl, isobutyl or tert-butyl group.

In the present document, the term “polymer” firstly embraces a collective of macromolecules which are chemically homogeneous but different in relation to degree of polymerization, molar mass and chain length, which has been prepared by a poly reaction (polymerization, polyaddition, polycondensation). The term secondly also embraces derivatives of such a collective of macromolecules from poly reactions, i.e. compounds which have been obtained by reactions, for example additions or substitutions, of functional groups on given macromolecules, and which may be chemically homogeneous or chemically inhomogeneous. The term further also comprises what are known as prepolymers, i.e. reactive oligomeric preliminary adducts whose functional groups are involved in the formation of macromolecules.

The term “polyurethane polymer” embraces all polymers prepared by what is known as the diisocyanate polyaddition process. This also includes those polymers which are virtually or entirely free of urethane groups. Examples of polyurethane polymers are polyetherpolyurethanes, polyesterpolyurethanes, polyetherpolyureas, polyureas, polyesterpolyureas, polyisocyanurates and polycarbodiimides.

“Room temperature” refers to a temperature of 25° C.

Substance names beginning with “poly”, such as polyaldimine, polyisocyanate, polyol or polyamine, in the present document refer to substances which, in a formal sense, contain two or more of the functional groups which occur in their name per molecule.

The term “primary amino group” in the present document denotes an amino group in the form of an NH₂ group which is bonded to an organic radical. The term “secondary amino group” denotes an amino group in which the nitrogen atom is bonded to two organic radicals which may also together be part of a ring.

An “aliphatic amino group” refers to an amino group which is bonded to an aliphatic, cycloaliphatic or arylaliphatic radical. It thus differs from an “aromatic amino group” which is bonded directly to an aromatic or heteroaromatic radical, as, for example, in aniline or 2-aminopyridine.

A “primer” is understood in the present document to mean a composition which is suitable as an undercoat and comprises, as well as nonreactive volatile substances and optionally solid additives, at least one substance with isocyanate groups, and which is capable of curing, when applied to a substrate, to give a solid film with good adhesion in a layer thickness of typically at least 5 μm, the curing arising through the evaporation of the nonreactive volatile substances, for example solvents, or else through the chemical reaction of the isocyanate groups with water which leads to crosslinking, and which builds up good adhesion to a layer applied subsequently, especially an adhesive or sealant.

The broken lines in the formulae in this document each represent the bond between a substituent and the rest of the associated molecule.

A polyaldimine ALD of the formula (I) is obtainable by a condensation reaction with elimination of water between a polyamine of the formula (I a) and an aldehyde of the formula (I b). The aldehyde of the formula (I b) is used here stoichiometrically or in a stoichiometric excess in relation to the amino groups of the polyamine of the formula (I a).

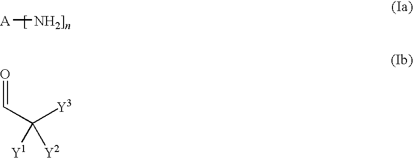

In the formulae (I a) and (I b), A, n and Y¹, Y² and Y³ are each as already defined.

Suitable polyamines of the formula (I a) are polyamines with aliphatic primary amino groups, for example the following: aliphatic polyamines such as ethylenediamine, 1,2- and 1,3-propanediamine, 2-methyl-1,2-propanediamine, 2,2-dimethyl-1,3-propanediamine, 1,3- and 1,4-butanediamine, 1,3- and 1,5-pentanediamine, 1,6-hexanediamine, 2,2,4- and 2,4,4-trimethylhexanediamine and mixtures thereof, 1,7-heptanediamine, 1,8-octanediamine, 4-aminomethyl-1,8-octanediamine, 1,9-nonanediamine, 1,10-decanediamine, 1,11-undecanediamine, 1,12-dodecanediamine, methylbis(3-aminopropyl)amine, 1,5-diamino-2-methylpentane (MPMD), 1,3-diaminopentane (DAMP), 2,5-dimethyl-1,6-hexanediamine, cycloaliphatic polyamines such as 1,3- and 1,4-diaminocyclohexane, bis(4-aminocyclohexyl)methane, bis(4-amino-3-methylcyclohexyl)methane, bis(4-amino-3-ethylcyclohexyl)methane, bis(4-amino-3,5-dimethylcyclohexyl)methane, 1-amino-3-aminomethyl-3,5,5-trimethylcyclohexane (=isophoronediamine or IPDA), 2- and 4-methyl-1,3-diaminocyclohexane and mixtures thereof, 1,3- and 1,4-bis(aminomethyl)cyclohexane, 1-cyclohexylamino-3-aminopropane, 2,5(2,6)-bis(aminomethyl)bicyclo[2.2.1]-heptane (NBDA, produced by Mitsui Chemicals), 3(4),8(9)-bis(aminomethyl)tricyclo[5.2.1.0^{2,6}]decane, 1,4-diamino-2,2,6-trimethylcyclohexane (TMCDA), 3,9-bis(3-aminopropyl)-2,4,8,10-tetraoxaspiro[5.5]undecane, 1,3- and 1,4-xylylene-diamine, ether-containing aliphatic polyamines such as bis(2-aminoethyl)ether, 4,7-dioxadecan-1,10-diamine, 4,9-dioxadodecane-1,12-diamine and higher oligomers thereof, polyoxyalkylenepolyamines having two or three amino groups, obtainable, for example, under the Jeffamine® name (from Huntsman Chemicals), under the Polyetheramine name (from BASF) or under the PC Amine® name (from Nitroil), and also mixtures of the aforementioned polyamines.

Preferred polyamines of the formula (I a) are polyamines which are selected from the group consisting of 1,6-hexanediamine, MPMD, DAMP, IPDA, 4-aminomethyl-1,8-octanediamine, 1,3-xylylenediamine, 1,3-bis(aminomethyl)cyclohexane, bis(4-aminocyclohexyl)methane, bis(4-amino-3-methylcyclohexyl)methane, 3(4),8(9)-bis(aminomethyl)tricyclo[5.2.1.0^{2,6}]decane, 1,4-diamino-2,2,6-trimethylcyclohexane and polyoxyalkylenepolyamines with two or three amino groups, especially the EDR-148, D-230, D-400, T-403 products available under the Jeffamine® tra dename from Huntsman, and analogous compounds from BASF or Nitroil, and mixtures thereof with one another.

Aldehydes of the formula (I b) are tertiary aliphatic or tertiary cycloaliphatic aldehydes, for example pivalaldehyde (=2,2-dimethylpropanal), 2,2-dimethylbutanal, 2,2-diethylbutanal, 1-methylcyclopentanecarboxaldehyde, 1-methylcyclohexanecarboxaldehyde; ethers formed from 2-hydroxy-2-ethylpropanal and alcohols such as propanol, isopropanol and butanol; esters formed from 2-formyl-2-methylpropionic acid or 3-formyl-3-methylbutyric acid and alcohols such as propanol, isopropanol and butanol; esters formed from 2-hydroxy-2-methylpropanal and carboxylic acids such as formic acid, acetic acid, propionic acid, butyric acid and isobutyric acid; and the ethers and esters, described hereinafter as particularly suitable, of 2,2-disubstituted 3-hydroxy-propanals, -butanals or analogous higher aldehydes, especially of 2,2-dimethyl-3-hydroxypropanal.

In one embodiment, particularly suitable aldehydes of the formula (I b) are aldehydes of the formula (II a), i.e. aldehydes of the formula (I b) with the Y³ radical of the formula (II)

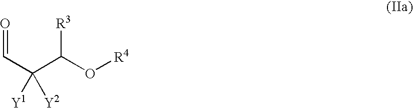

In formula (II a), Y¹ and Y² are preferably each a methyl group, and R³ is preferably a hydrogen atom.

Aldehydes of the formula (II a) are ethers of aliphatic, arylaliphatic or cycloaliphatic 2,2-disubstituted 3-hydroxyaldehydes with alcohols of the formula HO—R⁴. Suitable 2,2-disubstituted 3-hydroxyaldehydes are in turn obtainable from aldol reactions, especially crossed aldol reactions, between primary or secondary aliphatic aldehydes, especially formaldehyde, and secondary aliphatic, secondary arylaliphatic or secondary cycloaliphatic aldehydes, for example isobutyraldehyde, 2-methylbutyraldehyde, 2-ethylbutyraldehyde, 2-methylvaleraldehyde, 2-ethylcapronaldehyde, cyclopentanecarboxaldehyde, cyclohexanecarboxaldehyde and 1,2,3,6-tetrahydrobenzaldehyde.

Examples of such aldehydes of the formula (II a) include 2,2-dimethyl-3-methoxypropanal, 2,2-dimethyl-3-ethoxypropanal, 2,2-dimethyl-3-propoxypropanal, 2,2-dimethyl-3-isopropoxypropanal, 2,2-dimethyl-3-butoxypropanal and 2,2-dimethyl-3-hexyloxypropanal.

In a further embodiment, particularly suitable aldehydes of the formula

(I b) are aldehydes of the formula (III a), especially aldehydes of the formula (III b),

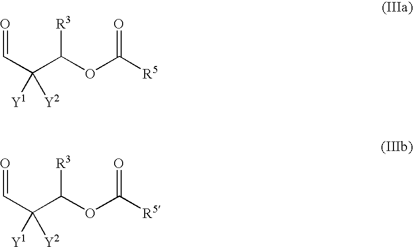

where R⁵′ is a methyl, ethyl, n-propyl, isopropyl, n-butyl, isobutyl or tert-butyl group.

Compounds of the formula (III a) and (Ill b) are esters of the 2,2-disubstituted 3-hydroxyaldehydes already described, for example 2,2-dimethyl-3-hydroxypropanal, 2-hydroxymethyl-2-methylbutanal, 2-hydroxymethyl-2-ethylbutanal, 2-hydroxymethyl-2-methylpentanal, 2-hydroxymethyl-2-ethylhexanal, 1-hydroxymethylcyclopentanecarboxaldehyde, 1-hydroxymethylcyclohexanecarboxaldehyde and 1-hydroxymethylcyclohex-3-enecarboxaldehyde, with suitable carboxylic acids.

Examples of suitable carboxylic acids are carboxylic acids such as formic acid, acetic acid, propionic acid, butyric acid, isobutyric acid, valeric acid, caproic acid, enanthic acid, cyclohexanecarboxylic acid and benzoic acid, for example.

In a preferred preparation method for the aldehyde of the formula (III a) or (III b), a 2,2-disubstituted 3-hydroxyaldehyde, for example 2,2-dimethyl-3-hydroxypropanal, which can be prepared, for example, from formaldehyde (or paraformaldehyde) and isobutyraldehyde, optionally in situ, is reacted with a carboxylic acid to give the corresponding ester. This esterification can be effected without the use of solvents by known methods, described, for example, in Houben-Weyl, “Methoden der organischen Chemie” [Methods of Organic Chemistry], Vol. VIII, pages 516-528.

The primer composition further comprises at least one polyisocyanate P.

In one embodiment, the polyisocyanate P is a monomeric diisocyanate or triisocyanate or an oligomer of a monomeric diisocyanate or triisocyanate, especially a biuret or an isocyanurate of a monomeric diisocyanate or triisocyanate.

Suitable polyisocyanates P are, for example, 1,6-hexamethylene diisocyanate (HDI), 2-methylpentamethylene 1,5-diisocyanate, 2,2,4- and 2,4,4-trimethyl-1,6-hexamethylene diisocyanate (TMDI), 1,10-decamethylene diisocyanate, 1,12-dodecamethylene diisocyanate, lysine diisocyanate and lysine ester diisocyanate, cyclohexane 1,3- and -1,4-diisocyanate and any mixtures of these isomers, 1-methyl-2,4- and -2,6-diisocyanatocyclohexane and any mixtures of these isomers (HTDI or H₆TDI), 1-isocyanato-3,3,5-trimethyl-5-isocyanatomethylcyclohexane (=isophorone diisocyanate or IPDI), perhydro-2,4′- and -4,4′-diphenylmethane diisocyanate (HMDI or H₁₂MDI), 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethyl-1,3- and -1,4-xylylene diisocyanate (m- and p-TMXDI), bis(1-isocyanato-1-methylethyl)naphthalene, 2,4- and 2,6-tolylene diisocyanate and any mixtures of these isomers (TDI), 4,4′-, 2,4′- and 2,2′-diphenylmethane diisocyanate and any mixtures of these isomers (MDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI), dianisidine diisocyanate (DADI), tris(p-isocyanatophenyl) thiophosphate, and oligomers of the aforementioned isocyanates. Preference is given to MDI, TDI, HDI, IPDI and tris(p-isocyanatophenyl) thiophosphate. Particular preference is given to TDI, HDI and tris(p-isocyanatophenyl) thiophosphate.

In a further embodiment, suitable polyisocyanates P are isocyanate-containing addition products of at least one polyol and at least one monomeric diisocyanate or triisocyanate, especially the monomeric diisocyanates or triisocyanates listed in detail in the preceding paragraph.

Such addition products are especially those with polyols having a molecular weight of less than 5000 g/mol, preferably less than 2500 g/mol.

Polyols especially suitable for such addition products are:
polyetherpolyols, also known as polyoxyalkylenepolyols, which are polymerization products of ethylene oxide, 1,2-propylene oxide, 1,2- or 2,3-butylene oxide, oxetane, tetrahydrofuran or mixtures thereof, possibly polymerized with the aid of a starter molecule with two or more active hydrogen atoms, for example water, ammonia or compounds having a plurality of OH or NH groups, for example 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and mixtures of the aforementioned compounds. It is possible to use either polyoxyalkylenepolyols which have a low degree of unsaturation (measured to ASTM D-2849-69 and reported in milliequivalents of unsaturation per gram of polyol (meq/g)), prepared, for example, with the aid of double metal cyanide complex catalysts (DMC catalysts), or polyoxyalkylenepolyols with a higher degree of unsaturation, prepared, for example, with the aid of anionic catalysts such as NaOH, KOH, CsOH or alkali metal alkoxides.

Particularly suitable polyetherpolyols are polyoxyalkylenediols and -triols, especially polyoxyalkylenediols. Particularly suitable polyoxyalkylenedi- and -triols are polyoxyethylenedi- and -triols and polyoxypropylenedi- and -triols. Likewise particularly suitable are so-called ethylene oxide-terminated (“EO-endcapped”, ethylene oxide-endcapped) polyoxypropylenepolyols. The latter are specific polyoxypropylenepolyoxyethylenepolyols which are obtained, for example, by further alkoxylating pure polyoxypropylenepolyols, especially polyoxypropylenediols and -triols, with ethylene oxide on completion of the polypropoxylation, and have primary hydroxyl groups as a result.
Polyesterpolyols which bear at least two hydroxyl groups, which are prepared by known processes, especially the polycondensation of hydroxycarboxylic acids or lactones or the polycondensation of aliphatic and/or aromatic polycarboxylic acids with di- or polyhydric alcohols.

Especially suitable polyesterpolyols are those prepared from di- to trihydric, especially dihydric, alcohols, for example ethylene glycol, diethylene glycol, propylene glycol, dipropylene glycol, neopentyl glycol, 1,4-butanediol, 1,5-pentanediol, 3-methyl-1,5-hexanediol, 1,6-hexanediol, 1,8-octanediol, 1,10-decanediol, 1,12-dodecanediol, 1,12-hydroxystearyl alcohol, 1,4-cyclohexanedimethanol, dimer fatty acid dial (dimer dial), neopentyl glycol hydroxypivalate, glycerol, 1,1,1-trimethylolpropane or mixtures of the aforementioned alcohols, with organic di- or tricarboxylic acids, especially dicarboxylic acids, or the anhydrides or esters thereof, for example succinic acid, glutaric acid, adipic acid, trimethyladipic acid, suberic acid, azelaic acid, sebacic acid, dodecanedicarboxylic acid, maleic acid, furnaric acid, dimer fatty acid, phthalic acid, phthalic anhydride, isophthalic acid, terephthalic acid, dimethyl terephthalate, hexahydrophthalic acid, trimellitic acid and trimellitic anhydride, or mixtures of the aforementioned acids, and also polyesterpolyols formed from ε-caprolactone and starters such as the aforementioned di- or trihydric alcohols.

Particularly suitable polyesterpolyols are polyesterdiols. Especially suitable polyesterdiols are those prepared from adipic acid, azelaic acid, sebacic acid, dodecanedicarboxylic acid, dimer fatty acid, phthalic acid, isophthalic acid and terephthalic acid as the dicarboxylic acid, and from ethylene glycol, diethylene glycol, neopentyl glycol, 1,4-butanediol, 1,6-hexanediol, dimer fatty acid dial and 1,4-cyclohexanedimethanol as the dihydric alcohol. Also especially suitable are polyesterdiols prepared from ε-caprolactone and one of the aforementioned dihydric alcohols as the starter.
Polycarbonatepolyols, as obtainable by polycondensation, for example, of the abovementioned dihydric or trihydric alcohols—used to form the polyesterpolyols—with dialkyl carbonates such as dimethyl carbonate, diaryl carbonates such as diphenyl carbonate, or phosgene.

Particularly suitable substances are polycarbonatediols, especially amorphous polycarbonatediols.
Block copolymers which bear at least two hydroxyl groups and have at least two different blocks with polyether, polyester and/or polycarbonate structure of the type described above.
Low molecular weight di- or polyhydric alcohols, for example 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, low molecular weight alkoxylation products of the aforementioned di- and polyhydric alcohols.

The molecular weight of the polyisocyanate P is preferably less than 4000 g/mol, especially less than 2000 g/mol, most preferably less than 1000 g/mol.

Preferred addition products are addition products of glycerol, 1,1,1-tri-methylolpropane and pentaerythritol with monomeric diisocyanates, especially with TDI. A particularly preferred addition product is the commercial product Desmodur® L75 (from Bayer).

The monomeric diisocyanate or triisocyanate mentioned is preferably an aromatic polyisocyanate.

The monomeric diisocyanate or triisocyanate mentioned is preferably selected from the group consisting of 2,4- and 2,6-tolylene diisocyanate and any desired mixtures of these isomers (TDI), 4,4′-, 2,4′- and 2,2′-diphenylmethane diisocyanate and any mixtures of these isomers (MDI), and tris(p-isocyanatophenyl) thiophosphate.

In a further embodiment, a suitable polyisocyanate P is a room temperature liquid form of polymeric MDI (PMDI). Polymeric MDI or PMDI refers to mixtures of MDI and MDI homologs. Commercially available types of PMDI are, for example, Desmodur® VL, Desmodur® VL 50, Desmodur® VL R 10, Desmodur® VL R 20 and Desmodur® VKS 20 F (from Bayer), Lupranat® M 10 R and Lupranat® M 20 R (from BASF), Isonate® M 309, Voranate® M 229 and Voranate M® 580 (from Dow), and Suprasec® 5025, Suprasec® 2050 and Suprasec® 2487 (from Huntsman).

The amount of the polyaldimine ALD of the formula (I) in the primer composition is preferably selected such that the ratio of aldimino groups to isocyanate groups present in the primer composition is 0.05 to 1, especially 0.1 to 0.3.

The primer composition preferably further comprises at least one solvent. The solvents used are especially ethers, ketones, esters or hydrocarbons, preferably tetrahydrofuran, methyl ethyl ketone, acetone, hexane, heptane, xylene, toluene or acetates, especially methyl acetate, ethyl acetate or butyl acetate.

Particularly suitable solvents are on the one hand those which have a boiling point at standard pressure of 100° C. or lower.

On the other hand, it may be advantageous in certain cases, for example when the aim is to formulate VOC-free primers or VOC-reduced primers, when the solvent used has a boiling point of greater than 250° C. at standard pressure or a vapor pressure of less than 0.1 mbar at 20° C. Such solvents are not considered to be VOC solvents (VOC=volatile organic compounds). Such solvents are especially selected from the group consisting of ethers, esters, hydrocarbons, ketones, aldehydes and amides.

The ethers mentioned are especially alkoxy-terminated polyols, especially alkoxy-terminated polyoxyalkylenepolyols, and also alkoxy-terminated polyetherpolyols. Examples thereof are polypropylene glycol dialkyl ethers or polyethylene glycol dialkyl ethers. Examples thereof are tetraglyme (tetraethylene glycol dimethyl ether), pentaglyme (pentaethylene glycol dimethyl ether), hexaglyme (hexaethylene glycol dimethyl ether), polyethylene glycol dimethyl ether, as sold commercially, for example, by Clariant under the Polyglycol DME 200 or Polyglycol DME 250 names, diethylene glycol dibutyl ether, polypropylene glycol dimethyl ether, polypropylene glycol dibutyl ether, polyethylene glycol monomethyl ether monoacetate and polypropylene glycol monomethyl ether monoacetate. Polypropylene glycol diethers have the advantage over the corresponding polyethylene glycol diethers that they typically possess better dissolution performance and are still liquid at higher molecular weights.

Especially suitable as esters are esters of carbonic acid or of monocarboxylic acids or polycarboxylic acids. Esters of carbonic acid include especially the dialkyl carbonates.

Esters of monocarboxylic acids include in particular esters of low molecular weight monocarboxylic acids, especially C₁-C₆-carboxylic acids, with fatty alcohols, and esters of low molecular weight alcohols, especially C₁- to C₆-alcohols, with fatty acids. Examples thereof are methyl laurate, ethyl laurate, methyl myristate and lauryl acetate.

Additionally suitable are esters of carboxylic acids with polyethylene glycols or polypropylene glycols.

Additionally suitable esters are organic phosphonates and phosphates.

Additionally suitable are cyclic esters, i.e. lactones.

Suitable amides are especially fatty acid amides or cyclic amides, i.e. lactams.

The primer composition optionally further comprises plasticizers. More particularly, the plasticizers are selected from the group consisting of phthalic esters, esters of aliphatic dicarboxylic acids, fatty acid esters and organic phosphoric esters. Suitable phthalic esters are especially the dialkyl phthalates, preferably of the C₈- to C₁₋₆-alcohols, especially dioctyl phthalate (DOP), dilsononyl phthalate (DINP) and diisodecyl phthalate (DIDP). Suitable esters of aliphatic dicarboxylic acids are especially the esters of adipic acid, azelaic acid and sebacic acid, for example dioctyl adipate (DOA), diisodecyl adipate (DIDA), dioctyl azelate (DOZ) and dioctyl sebacate (DOS).

However, it is preferred in most cases when highly volatile solvents are used, and not plasticizers or VOC-free solvents.

The primer composition may additionally further comprise at least one organoalkoxysilane, referred to hereinafter as “silane”, as an adhesion promoter. Examples of suitable silanes are aminosilanes, epoxysilanes, vinylsilanes, (meth)acryloylsilanes, isocyanatosilanes, carbamatosilanes, S-(alkyl-carbonyl)mercaptosilanes and aldiminosilanes; oligomeric forms of these silanes; and adducts of aminosilanes and/or mercaptosilanes with polyisocyanates, and also adducts of epoxysilanes with aminosilanes and/or with mercaptosilanes.

Suitable silanes are especially organoalkoxysilanes of the formula (VII).

R⁵—Si(R⁶)ₐ(OR⁷)₃₋ₐ (VII)

The R⁵ radical here is an alkyl radical having at least one functional group, especially an epoxy, (meth)acrylate ester, amine or vinyl group. Particularly advantageous groups are a methylene group or propylene group which bears a functional group. The R⁶ radical is an alkyl radical having 1 to 6 carbon atoms, especially methyl, and the R⁷ radical is an alkyl radical having 1 to 4 carbon atoms, especially methyl or ethyl. The index a is a value of 0, 1 or 2, especially a value of 0.

Examples of particularly suitable silanes of the formula (VII) are:
3-aminopropyltrimethoxysilane, 3-aminopropyldimethoxymethylsilane, 3-amino-2-methylpropyltrimethoxysilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyldimethoxysilane, aminomethylmethoxydimethylsilane, N-(2-aminoethyl)-3-aminopropyltrimethoxysilane, 3-[2-(2-aminoethylamino)ethylamino]propyltrimethoxysilane, N-(2-aminoethyl)-3-aminopropyltrimethoxysilane, bis(trimethoxysilylpropyl)amine, and the analogs thereof with ethoxy or isopropoxy groups instead of the methoxy groups on the silicon;
3-mercaptopropyltrimethoxysilane and 3-mercaptopropyltriethoxysilane;
2-(3,4-epoxycyclohexyl)ethyltrimethoxysilane, 2-(3,4-epoxycyclohexyl)ethyltriethoxysilane, 3-glycidyloxypropyltriethoxysilane and 3-glycidyloxypropyltrimethoxysilane;
3-(meth)acryloxypropyltriethoxysilane, 3-(meth)acryloxypropyltrimethoxysilane, vinyltrimethoxysilane and vinyltriethoxysilane.

If silanes are present, the proportion thereof in the overall primer composition is preferably 0.01-30% by weight, especially 0.1-20% by weight, preferably 0.2-10% by weight.

The primer composition may further comprise organotitanium compounds and/or organozirconium compounds as further adhesion promoters.

The organotitanium compound preferably bears at least one group which is hydrolyzed under the influence of water and leads to the formation of a Ti—OH group. Such an organotitanium compound preferably bears at least one functional group which is selected from the group comprising alkoxy groups, sulfonate groups, carboxylate groups, acetylacetonate, and combinations thereof, and which is bonded directly to the titanium atom via an oxygen-titanium bond.

Particularly suitable alkoxy groups have been found to be especially so-called neoalkoxy substituents, especially of the following structure:

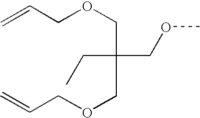

Particularly suitable sulfonic acids have been found to be especially alkyl-substituted aromatic sulfonic acids, especially p-dodecylbenzenesulfonic acid. Particularly suitable carboxylate groups have been found to be especially fatty acid carboxylates. A preferred carboxylate is decanoate.

The organozirconium compound preferably bears at least one group which is hydrolyzed under the influence of water and leads to the formation of a Zr—OH group. Such an organozirconium compound preferably bears at least one functional group which is selected from the group comprising alkoxy groups, sulfonate groups, carboxylate groups, phosphate and combinations thereof, and which is bonded directly to the zirconium atom via an oxygen-zirconium bond.

Particularly suitable alkoxy groups have been found to be especially isopropoxy and so-called neoalkoxy substituents, especially the structure also depicted for the organotitanium compounds. Particularly suitable sulfonic acids have been found to be especially alkyl-substituted aromatic sulfonic acids, especially p-dodecylbenzenesulfonic acid. Particularly suitable carboxylate groups have been found to be especially fatty acid carboxylates. A preferred carboxylate is stearate.

Organotitanium compounds and organozirconium compounds are commercially widely available for example from Kenrich Petrochemicals or from DuPont, for example the products NZ 38J, NZ TPPJ, KZ OPPR, KZ TPP, NZ 01, NZ 09, NZ 12, NZ38, NZ 44, NZ 97 from Kenrich Petrochemicals, Ken-React® KR TTS, KR 7, KR 9S, KR 12, KR 26S, KR 33DS, KR 38S, KR 39DS, KR44, KR 134S, KR 138S, KR 158FS, KR212, KR 238S, KR 262ES, KR 138D, KR 158D, KR238T, KR 238M, KR238A, KR238J, KR262A, LICA 38J, KR 55, LICA1, LICA 09, LICA 12, LICA 38, LICA 44, LICA 97, LICA 99, KR OPPR, KROPP2 from Kenrich Petrochemicals and Tyzor® ET, TPT, NPT, BTM AA, AA-75, AA-95, AA-105, TE, ETAM, OGT from DuPont.

If organotitanium compounds and/or organozirconium compounds are present, the proportion thereof in the overall primer composition is preferably 0.01-30% by weight, especially 0.1-20% by weight, preferably 0.2-10% by weight.

The primer composition typically further comprises at least one type of carbon black, especially industrially produced carbon black. The proportion of carbon black in the overall primer composition is preferably 2-20% by weight, especially 2-15% by weight, preferably 5-10% by weight.

The primer composition may comprise further constituents, for example catalysts, desiccants, thixotropic agents, dispersants, wetting agents, corrosion inhibitors, further adhesion promoters, UV and heat stabilizers, pigments, dyes and UV indicators.

Catalysts are firstly those which accelerate the reaction of the isocyanate groups with water. These are especially metal compounds, for example organotin compounds such as dibutyltin diacetate, dibutyltin dilaurate, dibutyltin dichloride, dibutyltin diacetylacetonate and dioctyltin dilaurate, bismuth compounds such as bismuth trioctoate and bismuth tris(neodecanoate), and compounds containing tertiary amino groups, such as 2,2′-dimorpholinodiethyl ether and 1,4-diazabicyclo[2.2.2]octane.

Catalysts are secondly those which accelerate the hydrolysis of the aldimino groups. These are especially acids or compounds hydrolyzable to acids, for example organic carboxylic acids such as benzoic acid, salicylic acid or 2-nitrobenzoic acid, organic carboxylic anhydrides such as phthalic anhydride, hexahydrophthalic anhydride and hexahydromethylphthalic anhydride, silyl esters of organic carboxylic acids, organic sulfonic acids such as methanesulfonic acid, p-toluenesulfonic acid or 4-dodecylbenzenesulfonic acid, sulfonic esters, other organic or inorganic acids, or mixtures of the aforementioned acids and acid esters.

The primer composition more preferably comprises a carboxylic acid, such as benzoic acid or salicylic acid, and/or a tin compound and/or a bismuth compound as a catalyst.

The primer composition may further comprise at least one binder. If binders are present, the binder content thereof in the overall primer composition is preferably 5-50% by weight, especially 10-30% by weight, preferably 15-25% by weight.

Suitable binders are especially polyester resins, epoxy resins, poly(meth)acrylate resins, polyvinyl acetates and polyvinyl acetals.

The primer composition described is suitable as an undercoat for adhesives and/or sealants. Use of such an undercoat improves the adhesion of the adhesive or sealant on the substrate.

The adhesive and/or sealant is especially an adhesive which contains moisture-reactive groups such as alkoxysilane groups and/or isocyanate groups. Such adhesives crosslink under the influence of water, especially of air humidity, and cure as a result.

The adhesive or sealant is preferably a moisture-curing polyurethane adhesive. Such adhesives comprise isocyanate-containing polyurethane polymers or prepolymers, which are preparable especially from polyols and polyisocyanates. Particular preference is given to one-pack moisture-reactive adhesives. Preferred adhesives are one-pack polyurethane adhesives, as sold commercially under the Sikaflex® product line by Sika Schweiz AG.

It has been found that the primer composition described is especially suitable for adhesives or sealants which comprise an aldimine. The aldimines present in the adhesive or sealant may be polyaldimines ALD of the formula (I). However, the aldimines described in WO 2004/013200 A1 are particularly advantageous.

The polyurethane adhesive or polyurethane sealant preferably comprises a polyaldimine ALD2 of the formula (IV) or (V).

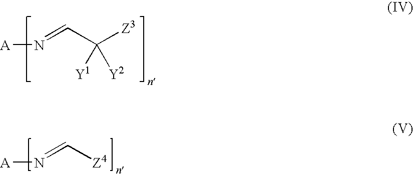

In these formulae, Z³ is a linear or branched hydrocarbon radical having 1 to 31 carbon atoms, optionally with cyclic and/or aromatic moieties and/or optionally with at least one heteroatom, especially with oxygen in the form of ether, ester or aldehyde groups. More particularly, Z³ is a radical of the formula (VI a) or (VI b).

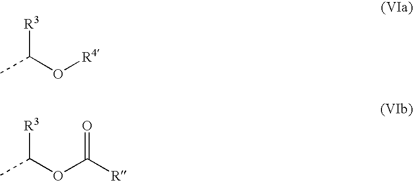

In these formulae, R^{4′} is an optionally heteroatom-containing hydrocarbon radical having 1 to 30, especially having 11 to 30, carbon atoms. R″ is a hydrogen atom; or is a linear or branched hydrocarbon radical having 1 to 29, especially having 11 to 29, carbon atoms, which optionally has cyclic moieties and/or at least one heteroatom; or is a mono- or polyunsaturated, linear or branched hydrocarbon radical having 5 to 29 carbon atoms; or is an optionally substituted aromatic or heteroaromatic 5- or 6-membered ring.

In addition, Z⁴ is a substituted or unsubstituted aryl or heteroaryl group which has a ring size between 5 and 8, preferably 6, atoms, and n′ is 2 or 3 or 4.

The possibilities for the A, Y¹, Y² and R³ radicals in the polyaldimine ALD2 of the formula (IV) or (V) are as already defined for the polyaldimine ALD of the formula (I). However, it should be noted that the individually selected radicals for polyaldimine ALD2 need not be the same as selected for the polyaldimine ALD. For example, the primer composition may comprise a polyaldimine ALD of the formula (I) in which Y¹ is a methyl group, while the adhesive comprises a polyaldimine ALD2 of the formula (IV) or (V) in which Y¹ is an ethyl group.

Preferred polyaldimines ALD2 are polyaldimines ALD2 of the formula (IV). Examples of particularly preferred aldimines are aldimines of the aldehydes which esterification products formed from 2,2-disubstituted 3-hydroxyaldehydes, especially selected from the group consisting of 2,2-dimethyl-3-hydroxypropanal, 2-hydroxymethyl-2-methylbutanal, 2-hydroxymethyl-2-ethylbutanal, 2-hydroxymethyl-2-methylpentanal, 2-hydroxymethyl-2-ethylhexanal, 1-hydroxymethylcyclopentanecarboxaldehyde, 1-hydroxymethylcyclohexanecarboxaldehyde, 1-hydroxymethylcyclohex-3-enecarboxaldehyde, 2-hydroxymethyl-2-methyl-3-phenylpropanal, 3-hydroxy-2-methyl-2-phenylpropanal and 3-hydroxy-2,2-diphenylpropanal, with a carboxylic acid selected from the group consisting of lauric acid, tridecanoic acid, myristic acid, pentadecanoic acid, palmitic acid, margaric acid, stearic acid, nonadecanoic acid, arachic acid, palmitoleic acid, oleic acid, linoleic acid, linolenic acid, elaeostearic acid, arachidonic acid, fatty acids from the industrial hydrolysis of natural oils and fats, for example rapeseed oil, sunflower oil, linseed oil, olive oil, coconut oil, oil palm kernel oil and oil palm oil, and industrial mixtures of fatty acids which comprise these acids. Aldehydes used with preference for this purpose are 2,2-dimethyl-3-lauroyloxypropanal, 2,2-dimethyl-3-myristoyloxypropanal, 2,2-dimethyl-3-palmitoyloxypropanal and 2,2-dimethyl-3-stearoyloxypropanal. Particular preference is given to 2,2-dimethyl-3-lauroyloxypropanal.

In one embodiment, the adhesive or sealant is a two-pack adhesive or sealant and consists of the two packs K1 and K2.

In a particularly preferred embodiment of the two-pack adhesive or sealant, pack K1 comprises at least one polymer with at least two isocyanate groups, and pack K2 comprises at least water. Preferably, one of packs K1 and K2, especially K1, further comprises an aldimine, especially a polyaldimine ALD2 of the formula (IV) or (V).

The primer composition can be applied by means of a cloth, felt, roller, spray, sponge, brush, by dip-coating or the like, and can be applied either manually or by means of robots.

A further aspect of the present invention relates to a process for adhesive bonding a substrate S1 to a substrate S2, which comprises the steps of:
i) applying a primer composition as described above to a substrate S1;
ii) flashing off the primer composition;
iii) applying a polyurethane adhesive to the flashed-off primer composition, or to a substrate S2;
iv) contacting the adhesive present on the primer composition with a substrate S2, or the adhesive present on the substrate S2, with the flashed-off primer composition, within the open time of the adhesive;
v) curing the adhesive.

The substrate S2 consists of the same material as or a different material than the substrate S1.

The surface of the substrate S2 may have been pretreated if required with a primer, especially with a primer composition described in detail above.

A further aspect of the present invention relates to a process for sealing, which comprises the steps of:
i′) applying a primer composition as described above to a substrate S1 and/or S2;
ii′) flashing off the primer composition;
iii′) applying a polyurethane sealant between the substrate S1 and the substrate S2, such that the polyurethane sealant is in contact with the substrate S1 and the substrate S2.

The substrate S2 consists of the same material as or a different material than the substrate S1, or the substrate S1 and substrate S2 together form one piece.

Substrates S1 and/or S2 suitable in these two processes are, for example, inorganic substrates such as glass, glass ceramic, concrete, mortar, brick, tile, plaster, and natural rocks such as granite or marble; metals or alloys such as aluminum, steel, nonferrous metals, galvanized metals; organic substrates such as leather, materials, paper, wood, resin-bound woodbase materials, resin-textile composite materials, polymers such as polyvinyl chloride (rigid and flexible PVC), acrylonitrile-butadiene-styrene copolymers (ABS), SMC (sheet molding composites), polycarbonate (PC), polyimide (PA), polyester, PMMA, polyester, epoxy resins, polyurethanes (PUR), polyoxy-methylene (POM), polyolefins (PO), polyethylene (PE) or polypropylene (PP) surface-treated especially by means of plasma, corona or flame, ethylene/propylene copolymers (EPN) and ethylene-propylene-diene terpolymers (EPDM); coated substrates such as powder-coated metals or alloys; and also paints and coatings, especially automotive coatings.

The substrates can, if required, be pretreated before the application of the composition. Such pretreatments comprise especially physical and/or chemical cleaning methods, for example grinding, sand-blasting, brushing or the like, or treatment with detergents or solvents, or the application of an adhesion promoter or of an adhesion promoter solution.

The substrate S1 and/or S2 is more preferably glass or glass ceramic. More particularly, the substrate S1 and/or S2 is a glass pane.

The possibilities and preferred embodiments for the adhesives or sealants usable in these processes have already been discussed above.

An article is obtained from the processes described.

This article is especially a built structure, especially a built structure in construction or civil engineering, or an industrial good or a consumer good, especially a window, a domestic appliance or a mode of transport, especially a water or land vehicle, preferably an automobile, a bus, a truck, a train or a ship, or an installable component of a mode of transport, or an article in the furniture, textile or packaging industry.

It has been found that the inventive primer compositions possess a significantly more rapid buildup of adhesion than the corresponding primers without aldimine. More particularly, this is also the case at low temperatures, i.e. <25° C., especially between 0° C. and 20° C., and/or low air humidities, i.e. <50% rel. air humidity, especially between 20 and 45% rel. air humidity, i.e. typical climatic conditions in winter. These advantageous properties are manifested especially in fast-curing adhesives.

However, it is particularly advantageous that this does not shorten the open time, i.e. the maximum time up to application of an adhesive or sealant. It has even been found that, at low temperatures and/or low air humidities, compared to the corresponding primers without aldimines, in spite of reduction in the minimum flashoff time, the open time can actually still be increased. The primers described thus have a particularly large time window within which they can be used as primers. Compared to primers comprising long-chain aldimines, the primers of the present invention have a prolonged open time. Finally, the primer compositions do not have an adverse effect on the curing of the adhesives.

### EXAMPLES

### Description of the Test Methods

Infrared spectra were measured on a Perkin-Elmer 1600 FT-IR instrument (horizontal ATR analysis unit with ZnSe crystal), and the substances were applied undiluted as a film. The absorption bands are reported in wavenumbers (cm⁻¹) (measurement window: 4000-650 cm⁻¹).

The amine content of the dialdimines prepared, i.e. the content of blocked amino groups in the form of aldimino groups, was determined by titrimetry (with 0.1N HClO₄ in glacial acetic acid, against crystal violet), and is always reported in mmol N/g.

Polyaldimines

Polyaldimine A-1

A round-bottom flask was initially charged under a nitrogen atmosphere with 50.0 g (0.35 mol) of 3-acetoxy-2,2-dimethylpropanal. While stirring vigorously, 55.0 g (0.35 mol of N) of polyetheramine (polyoxypropylene-triamine with a mean molecular weight of approx. 475 g/mol; Jeffamine® T-403, Huntsman; amine content 6.29 mmol N/g) was added slowly from a dropping funnel. Thereafter, the volatile constituents were removed under reduced pressure (10 mbar, 80° C.). Yield: 98.7 g of a colorless oil with an amine content of 3.50 mmol N/g.

IR(HATR, undiluted substance; “sh”=shoulder): 2966, 2930, 2868, 1740 (C═O), 1665 (C═N), 1469, 1460, 1394, 1373, 1344sh, 1330sh, 1292sh, 1237, 1149sh, 1103, 1039, 1007, 986, 943sh, 925, 874, 843, 783.

Polyaldimine A-2

A round-bottom flask was initially charged under a nitrogen atmosphere with 62.5 g (0.22 mol) of 2,2-dimethyl-3-lauroyloxypropanal. While stirring vigorously, 33.4 g (0.21 mol of N) of polyetheramine (polyoxypropylene-triamine with a mean molecular weight of approx. 475 g/mol; Jeffamine® T-403, Huntsman; amine content 6.29 mmol N/g) were added slowly from a dropping funnel. Thereafter, the volatile constituents were removed under reduced pressure (10 mbar, 80° C.). Yield: 92.1 g of a clear, pale yellow oil with an amine content of 2.28 mmol N/g.

Polyaldimine A-3

A round-bottom flask was initially charged under a nitrogen atmosphere with 74.3 g (0.26 mol) of distilled 2,2-dimethyl-3-lauroyloxy-propanal. While stirring vigorously, 30.0 g (0.25 mol of N) of polyetheramine (polyoxypropylenediamine with a mean molecular weight of approx. 240 g/mol; Jeffamine® D-230, Huntsman; amine content 8.29 mmol N/g) were added slowly from a dropping funnel. Thereafter, the volatile constituents were removed under reduced pressure (10 mbar, 80° C.). Yield: 99.5 g of a clear, pale yellow oil with an amine content of 2.50 mmol N/g.

Primer Compositions

Sika® Primer-206 G+P (referred to in table as “G+P”) (3.6% NCO) and Sika® Primer-2060T (referred to in table as “OT”)(4.0% NCO) are both primers commercially available from Sika Schhweiz AG, which comprise carbon black and polyisocyanate, and also solvent.

The aldimines A-1 and A-2 were added in the amount specified in table 1 while stirring under an inert atmosphere according to table 1 to 250 parts by weight of these primers. The amount of aldimines is calculated in such a way that the number of amino groups arising from the aldimine amounts to 20% of the NCO groups present. This can be calculated from knowledge of the aldimine group content (cf. “amine content”) of the aldimines.

Examples R1 and R3 thus correspond to the Sika® Primer-206 G-1-P and Sika® Primer-2060T respectively, without any addition.

Test Methods

The particular primers were applied by means of a brush to float glass which had been cleaned before use by wiping with a cellulose cloth (Tela®, Tela-Kimberly Switzerland GmbH) which had been soaked with Sika® activator, commercially available from Sika Schweiz AG, and flashed off for 10 minutes. After the flashoff time (“AZ”) specified in table 2 had elapsed (“10 m”=10 minutes, “1 d”=1 day, “7 d”=7 days), the adhesive specified was applied in the form of a round bead with a cartridge press and a nozzle to the flashed-off primer composition.

Adhesives

The adhesives used were the adhesives Sikaflex®-250 DM-2 which is commercially available from Sika Schweiz AG (“DM-2”), and the two-pack adhesive KS-1 described below.

Adhesive KS-1

The first pack was produced as follows:

In a vacuum mixer, 400 g of polyurethane polymer P-1, the preparation of which is described below, 170 g of diisodecyl phthalate (DIDP; Palatinol® Z, BASF), 40 g of hydrophobic fumed silica (Aerosil® R972, Degussa), 120 g of carbon black, 220 g of calcined kaolin, 50 g of polyaldimine A-3, 0.5 g of p-toluenesulfonyl isocyanate (TI additive, Bayer) and 2 g of a solution of 5% by weight of salicylic acid in dioctyl adipate were mixed at 40° C. to give a homogeneous paste, and the mixture was immediately transferred to internally coated aluminum cartridges which were sealed airtight.

The polyurethane polymer P-1 was prepared as follows:

1300 g of polyoxypropylenediol (Acclaim® 4200 N, Bayer; OH number 28.5 mg KOH/g), 2600 g of polyoxypropylenepolyoxyethylenetriol (Caradol® MD34-02, Shell; OH number 35.0 mg KOH/g), 600 g of 4,4′-methylenediphenyl diisocyanate (4,4′-MDI; Desmodur® 44 MC L, Bayer) and 500 g of diisodecyl phthalate (DIDP; Palatinol® Z, BASF) were converted at 80° C. to a prepolymer with a content of free isocyanate groups of 2.05% by weight.

The second pack was produced as follows:

In a vacuum mixer, 72.7 g of polyurethane polymer P-2, the preparation of which is described below, 17.3 g of polyaldimine A-3, 0.3 g of salicylic acid solution (5% by weight in dioctyl adipate) and 90.0 g of polyethylene glycol dibutyl ether (Polyglycol BB 300, Clariant; mean molecular weight 300) were mixed homogeneously and heated to 60° C. 61 g of water were stirred in and the mixture was stirred at 60° C. over 20 minutes. Then 3 g of technical-grade sodium dodecylbenzenesulfonate (Rhodacal® DS-10, Rhodia), 3 g of sodium tallate (Dresinate® TX, Eastman), 1.5 g of triethylamine, 22.5 g of polyethylene glycol dibutyl ether (polyglycol BB 300, Clariant; mean molecular weight 300), 15 g of hydrophilic fumed silica (Aerosil® 200, Degussa) and 15 g of hydrophobic fumed silica (Aerosil® R972, Degussa) were stirred in. The resulting paste had a water content of approx. 20% by weight.

The polyurethane polymer P-2 was prepared as follows:

4000 g of polyoxypropylenediol (Acclaim® 4200 N, Bayer; OH number 28.5 mg KOH/g) and 520 g of 4,4′-methylenediphenyl diisocyanate (4,4′-MDI; Desmodur® 44 MC L, Bayer) were converted at 80° C. to a prepolymer with a content of free isocyanate groups of 1.86% by weight.

To apply the adhesive, the first pack is mixed with the second pack in a volume ratio of 50:1.

Application and Testing

The particular primer compositions were applied by means of a brush to float glass which, before use, had been cleaned by wiping with a cellulose cloth (Tela®, Tela-Kimberly Switzerland GmbH) soaked with Sika® activator, commercially available from Sika Schweiz AG, and flashed off for 10 minutes. After the flashoff time (“AZ”) specified in table 2 had elapsed (“10 m”=10 minutes, “1 d”=1 day, “7 d”=7 days), the adhesive specified was applied in the form of a round bead by means of a cartridge pistol to the flashed-off primer composition, and the two packs in the case of the adhesive KS-7 were mixed by means of a static mixer.

The adhesion of the adhesive was tested by means of the “bead test” after the curing time specified in table 2 (“t_{Test}”) at 15° C. and 30-40% rel. air humidity. This involves incising at the end of the bead just above the adhesive surface. The incised end of the bead is held with rounded-end tweezers and pulled from the substrate. This is done by carefully rolling up the bead onto the tip of the tweezers, and by placing a cut at right angles to the direction of bead pulling down to the bare substrate. The bead pulling rate should be selected such that a cut has to be made about every 3 seconds. The test distance must be at least 8 cm long. After the bead has been pulled off, adhesive remaining on the substrate is assessed (cohesion fracture). The adhesion properties are assessed by estimating the cohesive component of the adhesive surface:

1=>95% cohesion fracture

2=75-95% cohesion fracture

3=25-75% cohesion fracture

4=<25% cohesion fracture

5=0% cohesion fracture (purely adhesive fracture)

“P” in the rating means detachment of the primer from the substrate.

Test results with cohesion fracture values of less than 75% are considered to be inadequate.

TABLE 1
Primers used.

| | R1 | 1 | R2 | R3 | 2 | R4 |
|---|---|---|---|---|---|---|
| A-1 | | 12.84 PW* | | | 11.56 PW* | |
| A-2 | | | 21.37 PW* | | | 11.56 PW* |
| OT | 250 PW* | 250 PW* | 250 PW* | | | |
| G + P | | | | 250 PW* | 250 PW* | 250 PW* |

*PW = parts by weight.

TABLE 2
Adhesions of different primer compositions to float glass.

| | | DM-2 | | | | | | |
|---|---|---|---|---|---|---|---|---|
| | t_{Test:} | | 2 | | | KS-1 | | |
| | AZ | 1 day | days | 5 days | 7 days | 2 days | 5 days | 7 days |
| R1 | 10 m | 3 | 3 | 3 | 1 | 5 | 5 | 1 |
| | 1 d | 5 | 5 | 2 | 1 | n.m.* | n.m.* | n.m.* |
| | 7 d | 5 | 5 | 5 | 5 | 5 | 4P | 1 |
| 1 | 10 m | 1 | 1 | 1 | 1 | 1 | 1 | 1 |
| | 1 d | 1 | 1 | 1 | 1 | n.m.* | n.m.* | n.m.* |
| | 7 d | 1 | 1 | 1 | 1 | 1 | 1 | 1 |
| R2 | 10 m | 2 | 1 | 1 | 1 | 1 | 1 | 1 |
| | 1 d | 1 | 1 | 1 | 1 | n.m.* | n.m.* | n.m.* |
| | 7 d | 4 | 2 | 1 | 1 | 2 | 1 | 1 |
| R3 | 10 m | 4 | 4 | 2 | 1 | 5P | 4P | 1 |
| | 1 d | 4 | 5 | 5 | 1 | n.m.* | n.m.* | n.m.* |
| | 7 d | 4 | 5 | 3 | 1 | 2 | 2P | 1 |
| 2 | 10 m | 1 | 1 | 1 | 1 | 2 | 1 | 1 |
| | 1 d | 1 | 1 | 1 | 1 | n.m.* | n.m.* | n.m.* |
| | 7 d | 1 | 1 | 1 | 1 | 1 | 1 | 1 |
| R4 | 10 m | 1 | 1 | 1 | 1 | 2 | 1 | 1 |
| | 1 d | 2 | 1 | 1 | 1 | n.m.* | n.m.* | n.m.* |
| | 7 d | 5 | 1 | 1 | 1 | 1 | 1 | 1 |

*n.m. = not measured.

For the tests in table 3, the adhesion was tested by means of the bead test after a curing time of 7 days of storage in a climate-controlled room (“KL”) at 23° C. and 50% relative air humidity, and after a subsequent storage in water (“WL”) at 23° C. over 7 days, and after a subsequent storage under hot and humid conditions (“CP”) at 70° C. and 100% relative air humidity over 7 days.

TABLE 3
Adhesions of Sikaflex ®-250 DM-2 to different
primers after different storage.

| | 1 | | | | R2 | | | | 2 | | | | R4 | | | |
|---|---|---|---|---|---|---|---|---|---|---|---|---|---|---|---|---|
| AZ[d] | 1 | 30 | 60 | 90 | 1 | 30 | 60 | 90 | 1 | 30 | 60 | 90 | 1 | 30 | 60 | 90 |
| KL | 1 | 1 | 1 | 1 | 1 | 3 | 3 | 3 | 1 | 1 | 1 | 1 | 1 | 3 | 3 | 3 |
| WL | 1 | 1 | 1 | 1 | 1 | 3 | 3 | 3 | 1 | 1 | 1 | 1 | 1 | 3 | 2 | 3 |
| CP | 1 | 1 | 1 | 1 | 1 | 2 | 2 | 3 | 1 | 1 | 1 | 1 | 1 | 1 | 1 | 2 |

The results of table 2 show that the inventive examples 1 and 2, compared to the primers (R1 and R3) without polyaldimines, lead to a significant improvement in adhesion. After as early as 10 minutes of flashoff time, good adhesion arises here even under disadvantageous climatic conditions, as frequently occur, for example, in winter. This good adhesion is maintained even after long flashoff times (7 days). Furthermore, it is evident from table 2 that, under these (cold, dry) conditions, the open time (maximum flashoff time, in the course of which subsequent adhesive bonding is still possible) of examples 1 and 2 is greater than 7 days, whereas it was less than 1 day or less than 7 days in the case of the reference examples (R1 to R4).

The results in table 3 show that the inventive primers 1 and 2 comprising a polyaldimine ALD, compared to the primer R4 comprising another polyaldimine, have improved adhesion after storage under water and after very long flashoff times (60 or 90 days).

1. A primer composition for adhesives or sealants, comprising:
at least one polyaldimine ALD of formula (I) 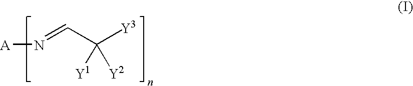
where:
A is remainder of a primary aliphatic amine after a removal of n primary amino groups;
Y¹ and Y² are each independently a monovalent hydrocarbon radical having 1 to 4 carbon atoms, or together are a divalent hydrocarbon radical having 4 to 5 carbon atoms;
Y³ is a branched or unbranched hydrocarbon radical having 1 to 8 carbon atoms, optionally with cyclic moieties and/or optionally with at least one heteroatom; and
n is 2 or 3; and
at least one polyisocyanate P.

2. The primer of claim 1, wherein Y¹ and Y² are each a methyl group.

3. The primer of claim 1, wherein Y³ is a radical of formula (II) 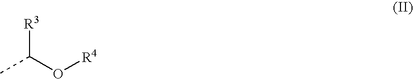
where:
R³ is a hydrogen atom or a linear or branched alkyl group having 1 to 4 carbon atoms; and
R⁴ is either a hydrocarbon radical having 1 to 7 carbon atoms or a 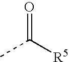
radical where R⁵ is a hydrogen atom or a hydrocarbon radical having 1 to 6 carbon atoms.

4. The primer of claim 1, wherein the polyisocyanate P is a monomeric diisocyanate or triisocyanate or an oligomer of a monomeric diisocyanate or triisocyanate, especially a biuret or isocyanurate of a monomeric diisocyanate or triisocyanate.

5. The primer of claim 1, wherein the polyisocyanate P is an isocyanate-containing addition product of at least one polyol and at least one monomeric diisocyanate or triisocyanate.

6. The primer of claim 4, wherein the monomeric diisocyanate or triisocyanate is an aromatic polyisocyanate.

7. The primer of claim 4, wherein the monomeric diisocyanate or triisocyanate is selected from the group consisting of 2,4- and 2,6-tolylene diisocyanate and any desired mixtures of these isomers (TDI), 1,6-hexamethylene diisocyanate (HDI), and tris(p-isocyanatophenyl) thiophosphate.

8. The primer of claim 1, wherein the polyisocyanate P is a room temperature liquid form of polymeric MDI (PMDI).

9. The primer of claim 1, wherein the polyaldimine ALD has formula (III) 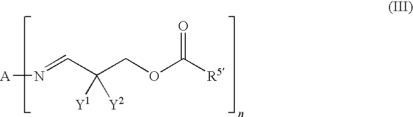
where R⁵′ is a methyl, ethyl, n-propyl, isopropyl, n-butyl, isobutyl or tert-butyl group.

10. The primer of claim 1, wherein the amount of the polyaldimine ALD of the formula (I) in the primer composition is selected such that the ratio of aldimino groups to isocyanate groups present in the primer composition is 0.05 to 1.

11. The primer of claim 1, wherein the primer composition further comprises carbon black.

12. The primer of claim 1, wherein the primer composition further comprises a carboxylic acid, and/or a tin compound, and/or a bismuth compound as a catalyst.

13. The primer of claim 1, wherein the adhesive or sealant comprises a polyaldimine.

14. The primer of claim 1, wherein the adhesive or sealant is a moisture-curing polyurethane adhesive.

15. The primer of claim 14, wherein the adhesive is a two-pack adhesive and consists of two packs K1 and K2, pack K1 comprising at least one polymer with at least two isocyanate groups, and pack K2 comprising at least water.

16. A process for adhesive bonding a substrate S1 to a substrate S2, which comprises the steps of
i) applying a primer of claim 1 to a substrate S1;
ii) flashing off the primer composition;
iii) applying a polyurethane adhesive to the flashed-off primer composition, or to a substrate S2;
iv) contacting the adhesive present on the primer composition with a substrate S2, or the adhesive present on the substrate S2, with the flashed-off primer composition, within an open time of the adhesive; and
v) curing the adhesive;
where the substrate S2 consists of the same material as or a different material than the substrate S1.

17. The process as claimed in claim 16, wherein the surface of the substrate S2 has been pretreated with a primer according to claim 1.

18. A process for sealing, which comprises the step of
i′) applying a primer composition of claim 1 to a substrate S1 and/or S2;
ii′) flashing off the primer composition; and
iii′) applying a polyurethane sealant between the substrate S1 and the substrate S2, such that the polyurethane sealant is in contact with the substrate S1 and the substrate S2;
where the substrate S2 consists of the same material as or a different material than the substrate S1, or where the substrate S1 and substrate S2 form one piece.

19. The process as claimed in claim 16, wherein the substrate S1 and/or S2 is glass or glass ceramic.

20. The process as claimed in claim 16, wherein the polyurethane adhesive or polyurethane sealant comprises a polyaldimine.

21. The process as claimed in claim 20, wherein the polyurethane adhesive or polyurethane sealant comprises a polyaldimine ALD2 of formula (IV) or (V) 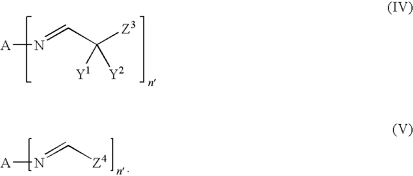
where Z³ is a linear or branched hydrocarbon radical having 1 to 31 carbon atoms, optionally with cyclic and/or aromatic moieties and/or optionally with at least one heteroatom;
Z⁴ is a substituted or unsubstituted aryl or heteroaryl group which has a ring size between 5 and 8;
n′ is 2 or 3 or 4;
A is a remainder of a primary aliphatic amine after a removal of n primary amino groups; and
Y¹ and Y² are each independently a monovalent hydrocarbon radical having 1 to 4 carbon atoms, or together are a divalent hydrocarbon radical having 4 to 5 carbon atoms;
where the A, Y¹, and Y² radicals of the polyamide ALD2 are independent of the radicals selected for the polyaldimine of formula (I).

22. An article which is obtained by a process as claimed in claim 16.

23. The article as claimed in claim 22, wherein the article is a built structure.

24. The process as claimed in claim 21, wherein:
Z₃ is a radical of the formula (VI a) or (VI b) 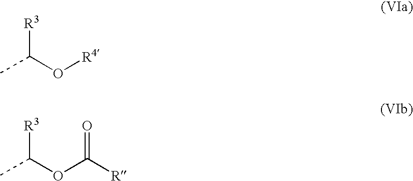
where:
R⁴′ is an optionally heteroatom-containing hydrocarbon radical having 1 to 30 carbon atoms; and
R″ is:
a hydrogen atom;
a linear or branched hydrocarbon radical having 1 to 29 carbon atoms, which optionally has cyclic moieties and/or at least one heteroatom;
a mono- or polyunsaturated, linear or branched hydrocarbon radical having 5 to 29 carbon atoms; or
an optionally substituted aromatic or heteroaromatic 5- or 6-membered ring.
